(19) United States
(12) Patent Application Publication
(10) Pub. No.: US 2015/0006038 A1
(43) Pub. Date: Jan. 1, 2015

(54) METHOD AND A DEVICE TO START AND SUSTAIN STRUCTURAL VIBRATIONS IN A STRUCTURAL COMPONENT

(71) Applicant: A2 Reasearch AB, Helsingborg (SE)

(72) Inventor: Mats Gustavsson, Helsingborg (SE)

(73) Assignee: A2 RESEARCH AB, Helsingborg (SE)

(21) Appl. No.: 14/371,836

(22) PCT Filed: Jan. 9, 2013
(86) PCT No.: PCT/EP2013/050276

§ 371 Date: Jul. 11, 2014

(30) Foreign Application Priority Data
Jan. 13, 2012 (SE) 1250014-6

(51) Int. Cl. B62D 21/15; H02P 25/02; H02N 2/00; F16F 7/12

(52) U.S. Cl. CPC B62D 21/152; F16F 7/12; H02P 25/027; H02N 2/008; H02P 2007/0077
USPC 701/45; 318/114

(57) ABSTRACT

The invention refers to a method and a device to start and sustain structural vibrations in a structural component having a compliance and a deformation behaviour, using a vibration actuator for generating vibrations, and a vibration sensor. The vibration actuator is controlled in response to the vibration sensor in such a manner that a specific vibration response is achieved for the structural component. The control is performed so that, when an impact is detected, the compliance and the deformation behaviour of the structural component are adapted to a desired compliance and a desired deformation behaviour depending on a specific external load to which the structural component is exposed as a consequence of said impact.

### FIELD OF THE INVENTION

The present invention is applied to structural components taking dynamic loads. More particularly, the present invention refers to adaptation of the structural properties of such structural components by means of inducing vibrations to improve the deformation properties when being exposed to load of transient nature. More specifically, the present invention relates to a method to start and sustain structural vibrations in a structural component having a compliance and a deformation behaviour, using at least one vibration actuator for generating vibrations. Moreover, the present invention refers to a system comprising a structural component.

### BACKGROUND

Structural components to deform and absorb impact energy, and thereby reduce the load on e.g. humans in a car, are well known and used within the automotive industry. Due to the infinite number of crash situations that can occur, the design of such structural components will be a compromise, which is often guided by the standardized crash tests in Europe (Euro NCAP) and the United States of America (NHTSA).

Various systems to improve the behaviour of a structural component at the occasion of a crash are known from e.g. U.S. Pat. No. 3,827,712, where a specific shape of a structural frame is defined. Adaptive systems, requiring a crash sensing capability are described in WO98/22327, where a crash sensing system is disclosed and the use with explosives aiming to change the compliance or rigidity of a structural component.

A method and a device for controlling the deformation shape of a structural component by means of imposing vibrations is known from WO2001/19666. This controlling is relaying on pre-defined estimates of the dynamics for the structural component to be brought into vibrations. Although a controllable signal is specified, the resulting vibration can vary quite significantly as a result of small errors in the pre-defined estimates of the structural dynamics of the structural component.

All structural components have specific dynamic properties when exposed to excitation at certain so called eigenmode frequencies, sometimes referred to as resonance frequencies. The dynamic response is to a high degree dominated by a certain vibration shape, an eigenmode shape, or mode shape, for excitation that coincides with the eigenmode frequency. This vibration shape is almost independent of the location and direction of the excitation. Further, the amplitude of the vibration is in such cases particularly high, compared to if the structural component is excited at a frequency not being close to an eigenmode frequency.

### SUMMARY

For simple geometries, like a straight, uniform homogenous beam, the eigenmode frequencies and associated mode shapes can often be described in terms of waves along the beam. Such waves can have the shape of bending, as illustrated in FIG. 6, torsion, as illustrated in FIG. 8, or longitudinal (axial), as illustrated in FIG. 7, or any combination thereof.

Hollow structural geometries will exhibit eigenmodes that are of the same type as mentioned above for a solid beam section, but also eigenmodes that are dominated by vibration amplitudes in panels of the hollow structural component, as illustrated in FIG. 9.

Determining eigenmode frequencies by dynamic excitation and dynamic response measurements is rather straight forward except if the eigenmodes are heavily damped, i.e. have a high loss factor, or if there are many eigenmode frequencies in the spectral range of interest, so called high modal overlap. Proper selection of the location for excitation and the location for response measurements enhance the ability to detect and characterize specific eigenmodes, with its associated eigenmode frequency.

Predictions of the eigenmode frequencies using modelling and analysis tools, such as methods based on the Finite Element Method, are considered quite accurate if giving an estimate within +/−5% from the true (measured) eigenmode frequency. Taking objects from serial production, such as cars, not only a discrepancy between analysis results and test results will occur, but also variations between the various objects will be found. This, as a result of production tolerances in dimensions, differences in material properties, and variations in the assembly.

Without having very precise estimates of the eigenmode frequencies for a structural component the actual response for excitation with a frequency close to an eigenmode frequency can vary quite significantly. As an example, a system having an eigenmode frequency at 2300 Hz may have almost the same vibration shape for excitation between 2200 Hz and 2400 Hz, but the vibration amplitude will be 5 times higher at 2300 Hz compared to excitation at 2200 Hz or 2400 Hz, with a 2% loss factor. The phase of the response relative to the excitation will be −13 degrees for excitation at 2200 Hz, −90 degrees for excitation at 2300 Hz, and −167 degrees for excitation at 2400 Hz. This means for an excitation at 2200 Hz the vibration displacement will be close to the maximum positive value when the force has its maximum positive value, while excitation at 2400 Hz will give a vibration displacement response close to the maximum negative value when the force has its maximum positive value. The effects above are illustrated in FIG. 11.

An object of the present invention is to provide a method and a device for controlling of the compliance and the deformation behaviour of a structural component in case of an external occasion, especially when the structural component is exposed to a transient external load, such as an impact. In particular, it is aimed at an adaptive controlling of the compliance and the deformation behaviour.

This object is achieved by a method to start and sustain structural vibrations in a structural component having a compliance and a deformation behaviour, using at least one vibration actuator for generating vibrations, and at least one vibration sensor, the method comprising the steps of controlling the at least one vibration actuator in response to the vibration sensor in such a manner that a specific vibration response is achieved for the structural component, so that, when an impact is detected, the compliance and the deformation behaviour of the structural component are adapted to a desired compliance and a desired deformation behaviour depending on a specific external load to which the structural component is exposed as a consequence of said impact. The structural component is thus mechanically forced to vibrate by means of the at least one vibration actuator, and the vibration response in the structural component is sensed by the at least one vibration sensor. The combination of a vibration actuator and a vibration sensor enables the inventive method and allows starting, controlling, and sustaining a certain vibration of the structural component.

The present invention permits improvement of the deformation behaviour of the structural component, such as slender structural components and thin-walled structural components, which are likely to buckle when exposed to external loads over a certain level. The buckling behaviour can be different for a rapidly applied load, such as an impact, than for a slowly changing load. The present invention is based on the fact that a disturbance of the state of a structural component, yet small in amplitude, small in internal and external forces, and consequently small in internal energy and externally applied energy, can significantly change the compliance or rigidity, and the deformation behaviour of the structural component.

The impact may be detected by means of any suitable impact detector, in the form of a pre-crash detection system or a crash detection system. Such a pre-crash detection system may be based on e.g. radar sensors in the front of the structural component, e.g. comprised by a vehicle and configured to detect an obstacle that is approaching the vehicle at a certain speed. A pre-crash detection system may, for example, allow for estimating if an obstacle is likely to impact the structural component, or e.g. the vehicle in a full frontal contact, an offset frontal contact, an impact from the side, or any combination thereof. Based on such an impact detection, the optimal vibration behaviour for the expected type of impact, and an estimate of the impact speed, may be defined. Vibrations may be started by means of a drive signal supplied by a control unit and fed into the vibration actuator. Continuous sensing of the vibrations, by means of the vibration sensor, may be fed back to the control unit, and with a control algorithm comprised by the control unit, the drive signal may be adapted in order to match the desired vibration, in particular the vibration at the moment of impact.

The vibration sensor, or several vibration sensors, are to be selected and installed to sense structural vibrations, in particular such vibrations being the result of a controllable applied excitation. The vibration measurement capability of the at least one vibration sensor allows for determining the vibration amplitude and phase at the point of measurement, but also to estimate the vibration amplitude and phase at regions of the structural component without vibration sensors, by the use of models of the dynamics for the structural component. Such models can typically be based on the Finite Element Method and eigenmode theory.

One use of the invention is to apply vibrations to prepare for an identified subsequent potential transient load that leads to a permanent, non-recoverable, deformation of a structural component where the initiated vibrations change the dynamic compliance and deformation of the structural component in a way that it reduce the damage of the structure itself, or reduce the loads and damage to objects, including humans, to be protected by the structural component. This could be used e.g. for improving the crash safety of a vehicle or other products used for transportation of humans, such as a car, truck, train or aircraft, or for transportation of goods.

Another use of the invention is to apply vibrations to prepare for an identified subsequent potential transient load where the vibrations change the dynamic stiffness and deformation of the structural component to get a more advantageous elastic, recoverable, deformation of the structural component. This could be used e.g. for a suspension system for a vehicle, a transportation container or other product which could benefit from having an advantage of being able to changing the compliance and deformation properties at certain identified potential load conditions.

Furthermore, the invention makes it possible to initiate or exaggerate a natural buckling behaviour of a structural component. This could in particular be used for thin-walled cross sections, and used to control global, as well as local buckling shapes for individual panels or panel segments.

In contrast, the invention may be used to suppress a default deformation of the structure, and instead guiding the structure to deform according to the imposed vibration with the deformation, the strains, and the stresses as primary quantities for this guidance.

Furthermore, the invention makes it possible to apply vibrations to induce stresses such that the combination of vibration induced stresses and the stresses from the external load exceeds the yield stress for the material in certain regions of the structure. This can be the result of any combination of transversal vibrations, torsional vibrations, longitudinal vibrations and the effect of the external load.

According to an embodiment of the invention, the desired compliance and the desired deformation behaviour is achieved from a combination of a deformation due the generated vibrations and a deformation due to the external load. Advantageously, a geometric effect of the combination is used to give the desired compliance or rigidity, and the desired deformation behaviour.

According to an embodiment of the invention, the combination is used to give strains or stresses in the structural component such that the structural component develops the desired deformation behaviour comprising or consisting of non-recoverable deformations. Several mechanical phenomena are possible to use by the inventive method. A direct consequence of the generated vibrations is the additional strains and stresses as a result of the vibrations. This may be used to force material changes like initiation of yield, which dramatically changes the compliance, the rigidity, the momentary deformation, and the subsequent deformations. The geometric effects of the vibrations can be used to initiate, or enhance, geometric effects like buckling. It should be noted that both elastic conditions as well as plastic, non-recoverable, conditions may be affected by the induced vibrations.

According to an embodiment of the invention, the method comprises the preceding step of:
detecting and selectively exciting structural eigenmodes of the structural component to enable achievement of said specific vibration response.

According to an embodiment of the invention, the method comprises the preceding step of:
identifying structural dynamic properties of the structural component by the use of the at least one vibration actuator for generating vibrations, and the at least one vibration sensor. The structural eigenmodes of the structural component are determined from the structural dynamic properties.

By the use of the identified structural dynamic properties and by exciting certain eigenmodes, the deformation behaviour for a structural component exposed to transient loads may thus be improved. In one aspect of the invention one single mode may be excited. In another aspect a combination of modes may be excited. This combination of modes may include modes of the same type, e.g. transversal modes, or a combination of transversal, torsional and longitudinal modes. In yet another aspect of the invention modes with vibration shape similar to buckling of a cross section of a structural component with panel areas may be excited, thereby allowing the control of the compliance or rigidity, and the deformation behaviour of the structural component in an advantageous manner.

According to an embodiment of the invention, the structural dynamic properties are identified at pre-defined occasions, or based on a maximum time interval from the previous identification. If the structural component is comprised by a vehicle, the predefined occasion may advantageously comprise when a certain travelling speed is achieved for the vehicle, when the engine of the vehicle is started, when the vehicle is braked or when a certain level of retardation is achieved, at scheduled functional checks, or in relation to when the latest identification of such properties was made.

Detailed estimates of the structural dynamics may be found from exciting the structural component and sensing, or measuring, the vibration, or dynamic, response. From the sensed vibration response, and the knowledge of the excitation signal, frequency response functions and impulse response functions can be derived. This allows for identifying eigenmodes and determine the eigenmode properties such as the eigenmode frequency and damping. If more than one vibration sensor is available, it may also be possible to estimate the mode shape of any of the identified eigenmodes. Pre-determined eigenmode properties, e.g. from analysis using models of the structural component, or previous measurements for the present structural component, or for a similar structural component, may also be used in combination with the sensed structural dynamics properties to detail and enrich the characterization of the present structural dynamics properties such as the mode shape.

According to an embodiment of the invention, wherein the method comprises the step of: identifying the structural dynamic properties of the structural component to identify anomalies influencing the compliance and anomalies influencing the deformation behaviour in case the structural component is exposed to the external load. Variation of the structural dynamic properties may result from variations in environmental conditions, wear, other degradation or change of properties over time, or physical effects like non-linearity. Identification and tracking of such variations may thus also be one aspect of the invention.

The object is also achieved by the device initially defined, which is characterised in that the device comprises at least one vibration sensor communicating with the control unit and configured to be applied to the structural component to sense a vibration response in the structural component and in that the control unit is configured to control the at least one vibration actuator in response to the vibration sensor in such a manner that a specific vibration response is achieved for the structural component so that, when an impact is detected by the impact detector, the compliance and the deformation behaviour of the structural component are adapted to a desired compliance and a desired deformation behaviour depending on a specific external load to which the structural component is exposed as a consequence of said impact.

According to an embodiment of the invention, the at least one vibration actuator comprises at least one of a piezo-electric element and an electro-magnetic element.

According to an embodiment of the invention, the at least one vibration actuator is applied to the structural component at a first location and at a second location, and wherein the at least one actuator is configured to generate vibrations at the first location and reversed vibrations at the second location.

According to an embodiment of the invention, the impact detector comprises an absolute or relative motion detector, such as an accelerometer, a radar sensor, a sonar sensor, a camera or positioning system data.

According to an embodiment of the invention, the structural component is comprised by a vehicle, and wherein the device comprises a vehicle diagnostics system configured to identify anomalies influencing the compliance and anomalies influencing the deformation behaviour in case the structural component is be exposed to the external load, and to report a status of safety related to the structural component of the vehicle based on the identified anomalies. Thus, the device and the method of the present invention may use the identified structural dynamics properties as input for a condition monitoring system. The aim of such monitoring could be, but is not limited to, identification of degraded crash properties.

The object is also achieved by a system comprising a structural component and a device as defined above and configured to start and sustain vibrations in the structural component.

### BRIEF DESCRIPTION OF THE DRAWINGS

The present invention is now to be explained more closely through a description of preferred embodiments and with reference to the drawings attached hereto.

FIG. 1 discloses a perspective view of a first embodiment of a device according to the invention on a structural component comprised by a vehicle chassi.

FIG. 2 discloses a perspective view of the device of FIG. 1 on a structural component.

FIG. 3 discloses a perspective view of a second embodiment of a device according to the invention on a structural component.

FIG. 4 discloses a perspective view of a third embodiment of a device according to the invention on a structural component.

FIG. 5 discloses a perspective view of a fourth embodiment of a device according to the invention on a structural component.

FIG. 6 illustrates a bending eigenmode for a solid beam.

FIG. 7 illustrates a longitudinal eigenmode for a bar.

FIG. 8 illustrates a torsional eigenmode for a solid beam.

FIG. 9 illustrates an eigenmode for a thin-walled component.

FIG. 10A-C illustrates simulation results for a rectangular hollow section impacting a rigid surface for the case of no induced vibrations, FIG. 10A, for the case of inducing a 3 kHz vibration, FIGS. 10B and B′, and for the case of inducing a 4 kHz vibration, FIG. 10C.

FIG. 11 illustrates response variation for a simple dynamic system with an eigenmode frequency at 2300 Hz and a loss factor of 2%.

### DETAILED DESCRIPTION

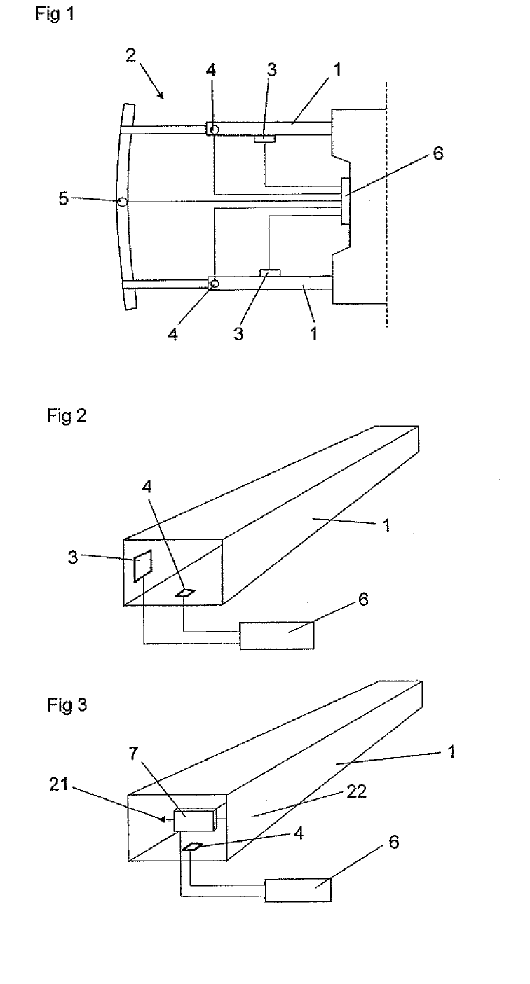

FIG. 1 discloses a device to start and sustain vibrations in a structural component 1 of a vehicle structure 2 of a car, partly disclosed. In the embodiment disclosed, the structural component 1 comprises or consists of a longitudinal beam of the vehicle structure. The device comprises a vibration actuator 3 and structural vibration sensor 4. The device also comprises an impact detector 5, and a control unit 6. The control unit 6 communicates with the vibration actuator 3, the vibration sensor 4 and the impact detector 5.

The vibration actuator 3 is applied or attached to the structural component 1 in order to be able to generate vibrations in the structural component 1. The vibration actuator 3 may comprise or consist of a piezo-electric element, an electro-magnetic element, an electro-mechanical element, an electro-static element, etc.

The vibration sensor 4 is also applied or attached to the structural component 1 in order to be able to sense vibrations in the structural component 1 and to provide a vibration response signal to be communicated to the control unit 6.

It is to be noted that the device may comprises more than one vibration actuators 3 and/or more than one vibration sensors 4, applied to the same structural component 1 or other structural components of the vehicle.

The impact detector 5, or a collision detector of any suitable kind, is configured to detect a subsequent specific external load. The impact detector 5 may comprise an absolute or relative motion detector, such as an accelerometer (crash detector), a radar sensor (pre-crash detector), a sonar sensor (pre-crash detector), a camera (pre-crash detector) or positioning system data (pre-crash detector). With such an impact detector it is possible to detect an external load a short time period before it actually takes place.

The control unit 6 is configured to control the vibration actuator 3 to generate vibrations in the structural component 1 at a detection of a potential impact situation, detected by the impact detector 5. The control unit 6 thereby supplies a drive signal to the vibration actuator 3 to generate or induce a desired vibration of the structural component 1. The vibration sensor 4 senses the vibrations and submit this information to the control unit 6 as the vibration response signal may be adapted in order to sustain or adapt the drive signal to the vibration actuator 3 depending on if the sensed vibration is the desired vibration. Updated information from the impact detector 5 may also be used to change the desired structural vibration if the collision conditions are detected to be changed.

FIG. 2 discloses device of the first embodiment with the structural component 1 in the form of a hollow beam that could be a vital part of a crash safety system for a vehicle, such as a car, truck, buss or other transportation mean. It is to be noted that elements having the same or similar function have been given the same reference signs in all embodiments and figures. In this embodiment, the vibration actuator 3 has a suspended mass that is brought to vibration and giving a resulting dynamic force to the structural component 1. The vibration sensor 4 provides means to sense structural vibrations in the structural component 1. The vibration actuator 3 and the vibration sensor 4 are both attached to an inner wall surface of the hollow beam. It should be noted that one or both of the vibration actuator 3 and the vibration sensor 4 may be attached to an outer wall surface of the hollow beam. The exact position of the vibration actuator 3 and the vibration sensor 4 may be determined by the skilled person depending on the geometry or the shape of the structural component 1. In FIG. 2, the hollow beam is disclosed as a straight beam. It should be noted that the beam also may be curved, or slightly curved.

FIG. 3 discloses a second embodiment of the device. Also in this embodiment, the structural component 1 may be a vital part of the crash safety system for a vehicle, such as a car, truck, buss or other transportation mean. The device of the second embodiment differs from the one of the first embodiment in that the vibration actuator and the vibration sensor are combined in a unified unit 7, e.g. a single piezo-electric element, that thus functions both as a vibration actuator and as a vibration sensor. Moreover, in the second embodiment, the vibration actuator 3 is applied to the structural component 1 at a first location 21 and at a second location 22. The vibration actuator 3 is configured to generate vibrations at the first location 21 and reversed vibrations at the second location 22. It is to be noted that the second embodiment may comprise a separate vibration sensor 4 and a vibration actuator 3 generating vibrations at the first location 21 and at the second location 22.

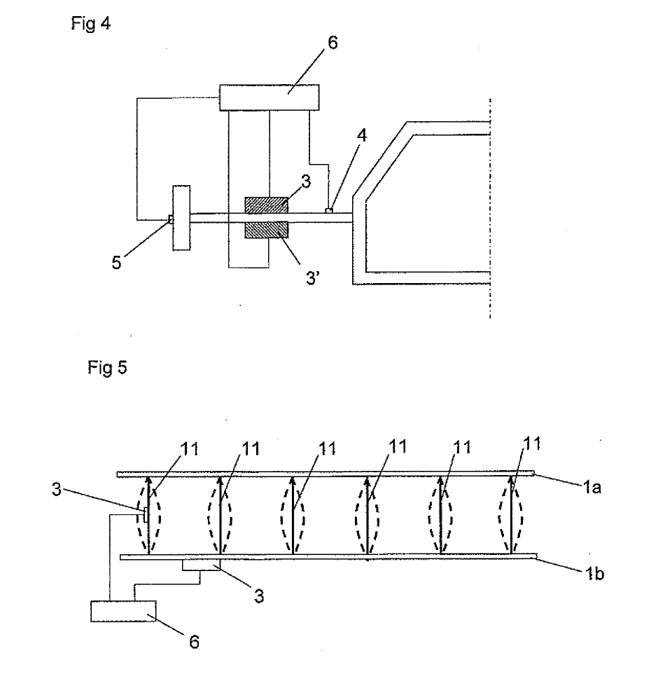

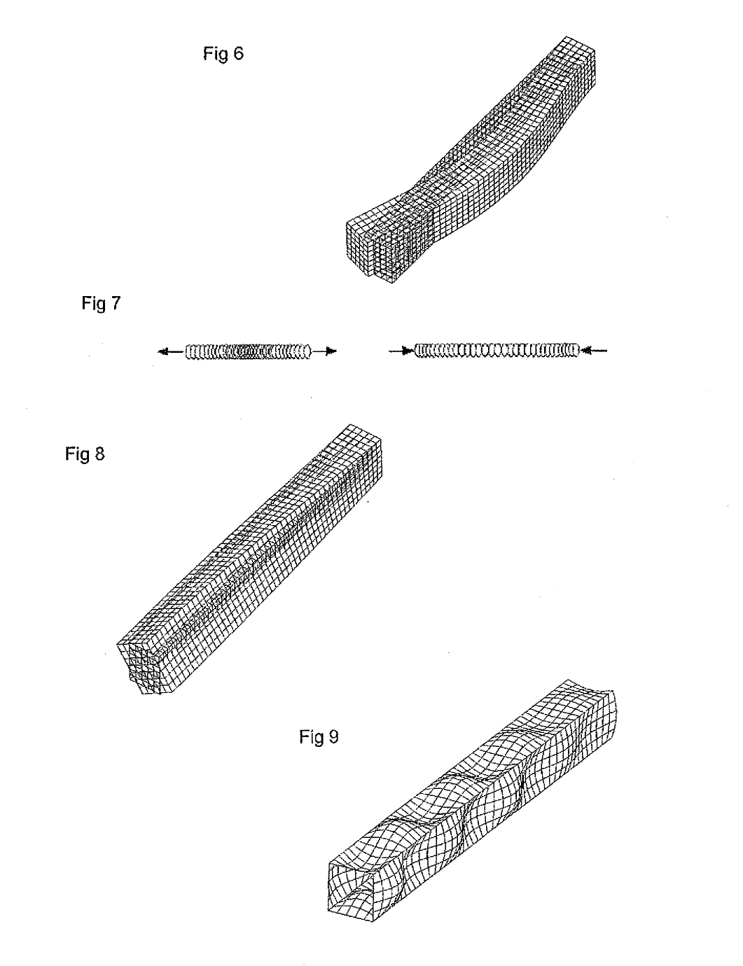

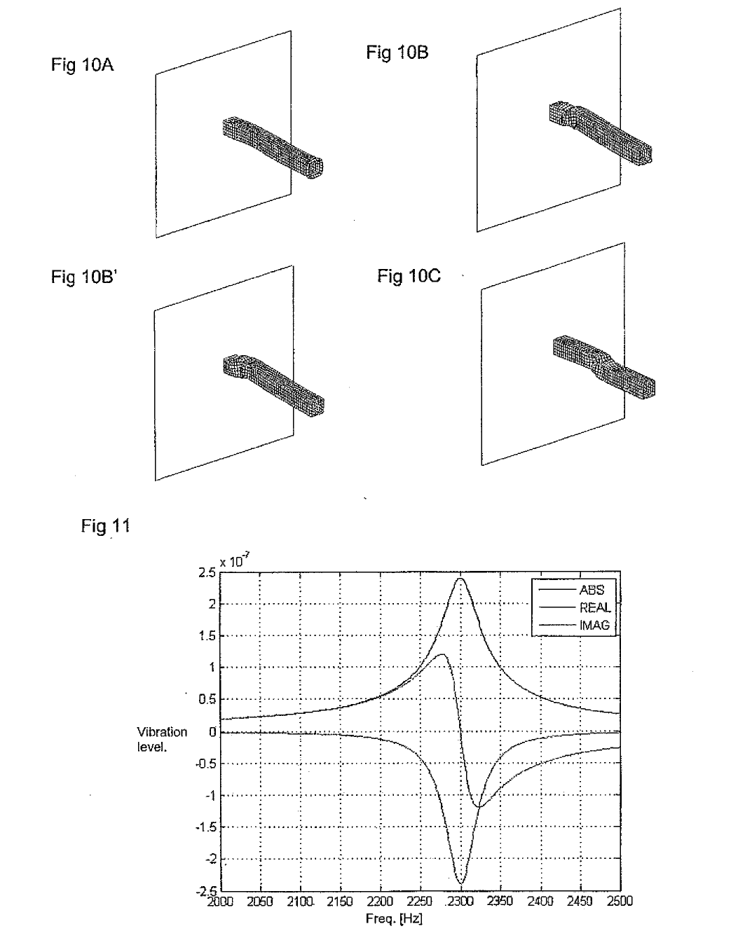

FIG. 4 discloses a third embodiment of the device with two structural vibration actuators 3 and 3′ attached to the structural component 1 of a vehicle body 2. As in the first and second embodiments, vibration actuators 3, 3′ are attached the structural component 1 in the form of a longitudinal beam of the vehicle structure. This structural vibration actuator arrangement is particularly efficient for selective excitation of longitudinal vibrations, as illustrated in FIG. 7 and bending vibrations as illustrated in FIG. 6. For longitudinal vibrations the two vibration actuators 3, 3′ are set to vibrate in-phase, while for bending vibrations the vibration actuators 3, 3′ are set to vibrate out-of-phase.

FIG. 5 discloses a fourth embodiment of the device on a structural component 1 comprising two parallel plane elements 1a, 1b joined to each other by cross-bars 11. The device comprises a vibration actuator 3 and a vibration sensor 4. All cross bars 11 can be brought to vibrate with the same vibration shape, of which one such shape is indicated by the dashed lines in the figure, by a proper selection of the excitation frequency and the installation of the vibration actuator 3. At the occasion of an external load F vibrations of the cross-bars 11 will change the compliance or rigidity of the structural component 1. If the external load is of a low magnitude or short duration, or a combination thereof, the deformations of the structural component 1 will be recoverable and the structure returns to the initial state when stopping the vibrations. If the external load is of a high magnitude or long duration, or a combination thereof, the deformation of the structural component 1 will be non-recoverable and deformations will remain after stopping the vibrations.

The present invention is not limited to the embodiments disclosed, but may be varied and modified within the scope of the following claims. Especially, the invention is not restricted to the structural components shown, but is generally applicable to structural components of any shape.

What is claimed is:

1-15. (canceled)

16. A method to start and sustain structural vibrations in a structural component having a compliance and a deformation behaviour, using at least one vibration actuator for generating vibrations, and at least one vibration sensor, the method comprising:
controlling the at least one vibration actuator in response to the vibration sensor in such a manner that a specific vibration response is achieved for the structural component, so that, when an impact is detected, the compliance and the deformation behaviour of the structural component are adapted to a desired compliance and a desired deformation behaviour depending on a specific external load to which the structural component is exposed as a consequence of said impact.

17. A method according to claim 16, wherein the desired compliance and the desired deformation behaviour is achieved from a combination of a deformation due the generated vibrations and a deformation due to the external load.

18. A method according to claim 17, wherein a geometric effect of the combination is used to give the desired compliance and the desired deformation behaviour.

19. A method according to claim 17, wherein the combination is used to give strains or stresses in the structural component such that the structural component develops the desired deformation behaviour comprising or consisting of non-recoverable deformations.

20. A method according to claim 16, wherein the method comprises the preceding step of:
detecting and selectively exciting structural eigenmodes of the structural component to enable achievement of said specific vibration response.

21. A method according to claim 16, wherein the method comprises the preceding step of:
identifying structural dynamic properties of the structural component by the use of the at least one vibration actuator for generating vibrations, and the at least one vibration sensor.

22. A method according to claim 20, wherein the structural eigenmodes of the structural component are determined from the structural dynamic properties.

23. A method according to claim 21, wherein the structural dynamic properties are identified at pre-defined occasions, or based on a maximum time interval from the previous identification.

24. A method according to claim 21, wherein the method comprises the step of:
identifying the structural dynamic properties of the structural component to identify anomalies influencing the compliance and anomalies influencing the deformation behaviour in case the structural component is exposed to the external load.

25. A device configured to start and sustain vibrations in a structural component having a compliance and a deformation behaviour, the device comprising:
at least one vibration actuator, configured to be applied to the structural component to generate vibrations in the structural component;
at least one impact detector, configured to detect a subsequent specific external load;
a control unit communicating with the at least one vibration actuator and the impact detector, and configured to control the vibration actuator to generate said vibrations in the structural component; and
at least one vibration sensor communicating with the control unit and configured to be applied to the structural component to sense a vibration response in the structural component and in that control unit is configured to control the at least one vibration actuator in response to the vibration sensor in such a manner that a specific vibration response is achieved for the structural component so that, when an impact is detected by the impact detector, the compliance and the deformation behaviour of the structural component are adapted to a desired compliance and a desired deformation behaviour depending on a specific external load to which the structural component is exposed as a consequence of said impact.

26. A device according to claim 25, wherein the at least one vibration actuator comprises at least one of a piezo-electric element and an electro-magnetic element.

27. A device according to claim 25, wherein the at least one vibration actuator is applied to the structural component at a first location and at a second location, and wherein the at least one actuator is configured to generate vibrations at the first location and reversed vibrations at the second location.

28. A device according to claim 25, wherein the impact detector comprises an absolute or relative motion detector, such as an accelerometer, a radar sensor, a sonar sensor, a camera or positioning system data.

29. A device according to claim 25, wherein the structural component is comprised by a vehicle, and wherein the device comprises a vehicle diagnostics system configured to identify anomalies influencing the compliance and anomalies influencing the deformation behaviour in case the structural component is be exposed to the external load, and to report a status of safety related the structural component of the vehicle based on the identified anomalies.

30. A system comprising a structural component and a device according to claim 25 and configured to start and sustain vibrations in the structural component.
